(19) United States
(12) Patent Application Publication
(10) Pub. No.: US 2015/0296426 A1
(43) Pub. Date: Oct. 15, 2015

(54) Methods and Network Nodes for Assisting Handover

(71) Applicant: TELEFONAKTIEBOLAGET L M ERICSSON (PUBL), Stockholm (SE)

(72) Inventors: Gunnar Mildh, Sollentuna (SE); Gino Luca Masini, Stockholm (SE); Angelo Centonza, Winchester (GB); Oumer Teyeb, Solna (SE); Fredrik Gunnarsson, Linkoping (SE); Stefan Wager, Espoo (FI); Mojgan Fadaki, Solna (SE)

(21) Appl. No.: 14/440,759

(22) PCT Filed: Apr. 16, 2013
(86) PCT No.: PCT/SE2013/050414

§ 371 Date: May 5, 2015

Related U.S. Application Data
(60) Provisional application No. 61/679,253, filed on Aug. 3, 2012.
(60) Provisional application No. 61/751,455, filed on Jan. 11, 2013.

(51) Int. Cl. H04W 36/00; H04W 36/32

(52) U.S. Cl. CPC H04W 36/0055; H04W 36/32; H04W 36/0083; H04W 88/04

(57) ABSTRACT

It is presented a method for assisting handover of wireless devices from a source network node to a target network node. The method is performed in the source network node and comprises: determining that a first wireless device belongs to a mobility group, wherein the mobility group comprises at least two wireless devices served by the source network node determined to share mobility characteristics; receiving a measurement report from a wireless device belonging to the mobility group; determining, based on the measurement report, that at least the first wireless device should be handed over to the target network node; and transmitting a message to the target network node, wherein the message indicates that the first wireless device belongs to the mobility group. A corresponding source network node, target network node and associated method are also presented.

### TECHNICAL FIELD

The invention relates to handover from a source network node to a target network node in a cellular communication network.

### BACKGROUND

In cellular networks, handovers are used to transfer radio access for a wireless terminal from a source network node to a target network node.

Handovers involve a significant amount of resources including signalling and hardware resources, and any solution to reduce resource requirements is beneficial.

In cellular networks where a group of wireless devices exhibit similar behaviour in terms of radio conditions and/or movement, relay devices can be used to provide relayed access for the wireless devices of the group. The relay device acts as a radio base station to the wireless devices and provides a combined radio connection link in the cellular radio communication network. When the group of wireless devices moves, a handover may be required. By using the relay device, the handover only needs to be performed for the relay device, and not for the individual wireless devices connected to the relay device, simplifying resource requirements and failure risks at handover. However, this solution requires that such relay devices are installed where they may be used, which can be costly and cumbersome.

### SUMMARY

It is an object to provide a way to assist handover of wireless devices when wireless terminals share mobility characteristics.

According to a first aspect, it is presented a method for assisting handover of wireless devices from a source network node to a target network node. The method is performed in the source network node and comprises: determining that a first wireless device belongs to a mobility group, wherein the mobility group comprises at least two wireless devices served by the source network node determined to share mobility characteristics; determining that at least the first wireless device should be handed over to the target network node; and transmitting a message to the target network node, wherein the message indicates that the first wireless device belongs to the mobility group. This preserves the mobility group information in handover situations. In this way, the target network node does not need to identify a mobility group from scratch, which can save significant resources.

The method may further comprise receiving a measurement report from a wireless device belonging to the mobility group. In such a case, the determining that at least the first wireless device should be handed over to the target network node is based on the measurement report.

In the transmitting, the message may be a handover request message.

The message may comprise information regarding how the mobility group was first identified. This information can be used by the target node as an indicator of how reliable the mobility grouping is, which can be used by the target network node to determine how often the mobility group should be revalidated. For example, a more reliable group may not need to be revalidated as a less reliable group.

An identifier of the mobility group may be a globally unique identifier of the mobility group. This makes it possible (e.g. for statistical purposes) for the network to track a given wireless device mobility groups movement through the network.

The method may further comprise transmitting mobility group history data, comprising information about activities of wireless devices of the mobility group. This history data can be used by target network node for statistical purposes or to optimize the treatment of the wireless terminals belonging to this group.

The mobility group history data may comprise at least one of: duration of the mobility group being connected to the source network node, duration of the mobility group staying together, movement speed of the mobility group, positioning data of the mobility group, timing advance data of the mobility group, visited cells of the mobility group, and data activity of wireless devices of the mobility group.

The transmitting a message to the target network node may comprise transmitting a composite message comprising bearer information of all wireless devices belonging to the mobility group. Such a composite message saves signalling resources.

The transmitting a message to the target network node may comprise transmitting a message comprising an identifier of the mobility group, and the message may omit any identifiers of wireless devices. This saves signalling resources further, but the target network node would then need to obtain the identifier(s) of the member(s) elsewhere, e.g. using a specific request to a node in the network holding this information.

According to a second aspect, it is presented a source network node arranged to assist handover of wireless devices from the source network node to a target network node. The source network node comprises: a processor; and a computer program product storing instructions. The instructions, when executed by the processor, causes the source network node to: determine that a first wireless device belongs to a mobility group, wherein the mobility group comprises at least two wireless devices served by the source network node determined to share mobility characteristics; determine that at least the first wireless device should be handed over to the target network node; and transmit a message to the target network node, wherein the message indicates that the first wireless device belongs to the mobility group.

The source network node may further comprise instructions to receive a measurement report from a wireless device belonging to the mobility group. In such a case, the instructions to determine that at least the first wireless device should be handed over to the target network node is based on the measurement report.

The message may be a handover request message.

The message may comprise information regarding how the mobility group was first identified.

An identifier of the mobility group may be a globally unique identifier of the mobility group.

The source network node may further comprise instructions to transmit mobility group history data, comprising information about activities of wireless devices of the mobility group.

The mobility group history data may comprise at least one of: duration of the mobility group being connected to the source network node, duration of the mobility group staying together, movement speed of the mobility group, positioning data of the mobility group, timing advance data of the mobility group, visited cells of the mobility group, and data activity of wireless devices of the mobility group.

The instructions to transmit a message to the target network node may comprise instructions to transmit a composite message comprising bearer information of all wireless devices belonging to the mobility group.

The instructions to transmit a message to the target network node may comprise instructions to transmit a message comprising an identifier of the mobility group, and the message may omit any identifiers of wireless devices.

According to a third aspect, it is presented a method for assisting handover of wireless devices from a source network node to a target network node. The method is performed in the target network node and comprises: receiving at least one message from the source network node, wherein the at least one message indicates that a first wireless device and a second wireless device both belong to a mobility group determined to share mobility characteristics; and reserving traffic resources for the first and second wireless device.

In the receiving, the message may be a handover request message.

The receiving at least one message may comprise receiving at least two handover requests from the source network node, each handover request comprising a wireless device identifier and a first mobility group identifier; and the method may further comprise: considering that wireless devices respectively associated with the at least two handover requests belong to the same mobility group identified by the first mobility group identifier.

The method may further comprise: determining a new identifier for a mobility group comprising the first wireless device and the second wireless device.

The method further comprise: reusing the identifier for the mobility group of the handover request in further handovers.

The method may further comprise: determining whether the mobility group is valid; and when the mobility group is determined not to be valid, considering the first wireless device and second wireless device not to belong to the same mobility group.

According to a fourth aspect, it is presented a target network node arranged to assist handover of wireless devices from a source network node to the target network node. The target network node comprises: a processor; and a computer program product storing instructions. The instructions, when executed by the processor, causes the target network node to: determine that a first wireless device belongs to a mobility group, wherein the mobility group comprises at least two wireless devices determined to share mobility characteristics; receive a measurement report from a wireless device belonging to the mobility group; determine, based on the measurement report, that at least the first wireless device should be handed over to the target network node; and transmit a message to the target network node, wherein the message indicates that the first wireless device belongs to the mobility group.

The message may be a handover request message.

The instructions to receive at least one message may comprise instructions to receive at least two handover requests from the source network node, each handover request comprising a wireless device identifier and a first mobility group identifier; and the instructions may further comprise instructions to: consider that wireless devices respectively associated with the at least two handover requests belong to the same mobility group identified by the first mobility group identifier.

The target network node may further comprise instructions to: determine a new identifier for a mobility group comprising the first wireless device and the second wireless device.

The target network node may further comprise instructions to: reuse the identifier for the mobility group of the handover request in further handovers.

The target network node may further comprise instructions to determine whether the mobility group is valid; and to, when the mobility group is determined not to be valid, consider the first wireless device and second wireless device not to belong to the same mobility group.

According to a fifth aspect, it is presented a method for assisting handover of wireless devices from a source network node to a target network node. The method is performed in the source network node and comprises: determining that a first wireless device belongs to a mobility group, wherein the mobility group comprises at least two wireless devices served by the source network node determined to share mobility characteristics; determining that at least the first wireless device should be handed over to the target network node; and transmitting a message to the target network node, wherein the message allows the target network node to identify that the first wireless device belongs to the mobility group.

In the transmitting a message to the target network node, the message may indicate that the first wireless device belongs to the mobility group.

The transmitting a message to the target network node may comprise transmitting a message comprising an identifier of the mobility group, and the message may omit any identifiers of wireless devices. This saves signalling resources further, but the target network node would then need to obtain the identifier(s) of the member(s) elsewhere, e.g. using a specific request to a node in the network holding this information.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating a cellular network where embodiments presented herein may be applied;

FIG. 2 is a schematic diagram illustrating handover of a mobility group of wireless devices;

FIG. 3 is a schematic diagram illustrating timing advance in one example for two of the wireless terminals of FIG. 2;

FIG. 4 is a sequence diagram illustrating an example of signalling for handover of a wireless device from a source network node to a target network node;

FIGS. 5A-B are flow charts illustrating assisting handover of wireless devices from a source network node to a target network node in, performed in a source network node of FIG. 2;

FIGS. 6A-D are flow charts illustrating assisting handover of wireless devices from a source network node to a target network node in, performed in a target network node of FIG. 2; and

FIG. 7 is a schematic diagram illustrating some components of the network node of FIGS. 1 and 2.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

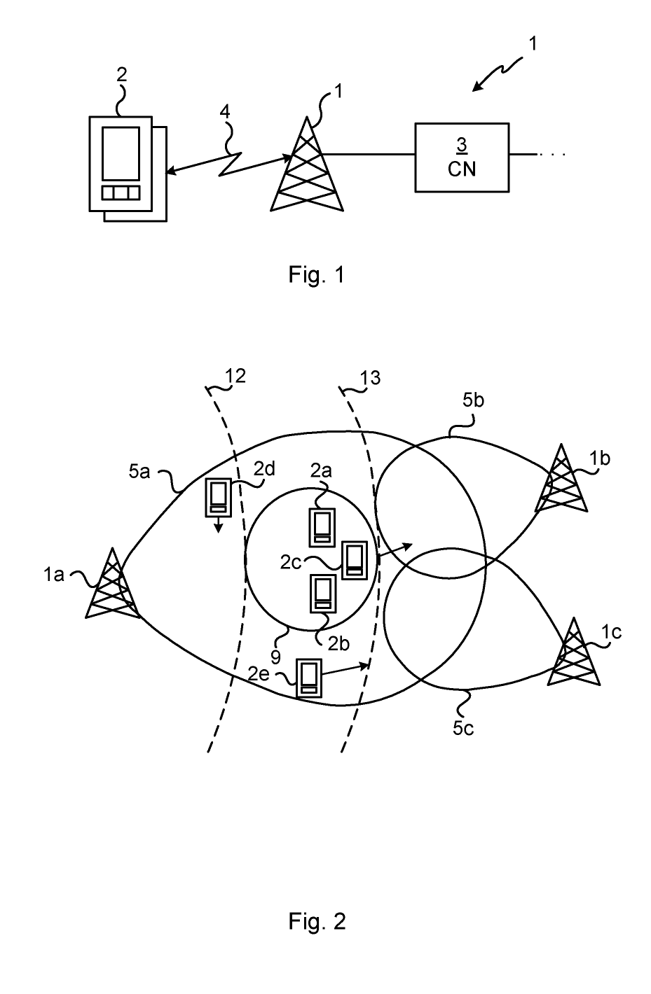

FIG. 1 is a schematic diagram illustrating a cellular network 8 where embodiments presented herein may be applied. The cellular communications network 8 comprises a core network 3 and one or more network nodes 1, here in the form of radio base stations or evolved Node Bs, also known as eNode Bs or eNBs. The network nodes 1 could also be in the form of Node Bs, BTSs (Base Transceiver Stations) and/or BSSs (Base Station Subsystems), etc. The network nodes 1 provide radio connectivity to a plurality of wireless devices 2. The term wireless device is also known as mobile communication terminal, user equipment, mobile terminal, user terminal, user agent, etc.

The cellular network 8 may e.g. comply with any one or a combination of LTE (Long Term Evolution), W-CDMA (Wideband Code Division Multiplex), EDGE (Enhanced Data Rates for GSM (Global System for Mobile communication) Evolution), GPRS (General Packet Radio Service), CDMA2000 (Code Division Multiple Access 2000), or any other current or future wireless network, as long as the principles described hereinafter are applicable.

Uplink and downlink communication between each wireless device 2 and the network node 1 occurs over a wireless radio interface 4. The quality of the wireless radio interface 4 to each wireless device 2 varies over time and also depends on the position of the wireless device 2, due to effects such as fading, multipath propagation, etc.

The one or more network nodes 1 are also connected to a core network 3 e.g. via an S1 interface (such as in LTE) for connectivity to central functions and other networks. The core network 3 can e.g. comprise nodes such as MME (Mobility Management Entity) and S-GW (Serving Gateway). When there are more than one network node 1, these can be connected with each other, e.g. via an X2 interface (such as in LTE).

FIG. 2 is a schematic diagram illustrating handover of a mobility group of wireless devices. The network nodes 1a-c correspond to the one or more network nodes 1 of FIG. 1 and the wireless devices 2a-e of correspond to the wireless device 2 of FIG. 1.

A first network node 1a provides coverage in a first cell 5a, a second network node 1b provides coverage in a second cell 5b and a third network node 1c provides coverage in third cell 5c. Other cells of other or shown network nodes 1a-c are omitted for reasons of clarity. For example each network node 1a-1c can, but does not need to, be responsible for more than one cell each, such as three cells each.

There is a first wireless terminal 2a, second wireless terminal 2b, third wireless terminal 2C, fourth wireless terminal 2d and fifth wireless terminal 2e, all within the coverage of the first cell 5a.

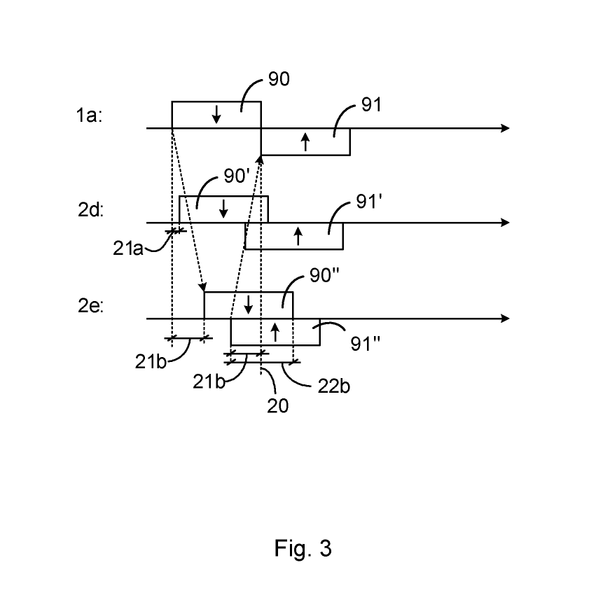

Now the concept of time alignment will be explained with reference to both FIG. 2 and FIG. 3. It can be seen that fourth wireless terminal 2d is located closer to the first network node 1a compared to the fifth wireless terminal 2e.

In order to preserve the orthogonality in uplink (UL), the UL transmissions from multiple wireless terminals can be time aligned at the network node.

Since wireless terminals may be located at different distances from the network node, as shown in FIG. 2, the wireless terminals will need to initiate their UL transmissions at different times. A wireless terminal far away from the network node needs to start transmission earlier than a wireless terminal close to the network node. This can for example be handled by a timing advance of an UL transmission where a wireless terminal starts its UL transmission before a nominal time given by the timing of the DL signal received by the wireless terminal. This concept is illustrated in FIG. 3.

The first network node 1a uses a downlink time slot 90 and an uplink time slot 91 for communication with the wireless terminals in the cell 5a of the first network node 1a.

Looking first from the perspective of the fifth wireless terminal 2e, due to the time it takes for signals to propagate to the fifth wireless terminal 2e, there is a time delay 21b until the fifth wireless terminal 2e starts its downlink time slot 90″. In order for the uplink time slot 91″ of the fifth wireless terminal 2e to be time aligned with the uplink time slot 91 of the first network node 1a, the uplink time slot 91″ of the fifth wireless terminal 2e has to start earlier than the time 20 when the uplink time slot 91 starts at the first network node 1a. The uplink transmission starts at an earlier time such that, after the time delay 21b for propagation, the uplink time slot 91 of the first network node 1a and the uplink time slot of the fifth wireless terminal 2e are aligned. The uplink time slot 91″ of the fifth wireless terminal 2e starts at an amount of time 22b prior to when the downlink time slot 90″ of the fifth wireless terminal 2e ends, i.e. timing advance (TA).

Analogously, the fourth wireless terminal 2d also needs to apply a timing advance value, e.g. relative to its downlink time slot 90′ to align its uplink time slot 91′ with the uplink time slot 91 at the first network node 1a. However, since the fourth wireless terminal is closer to the first network node 1a, the time delay 21a for propagation is smaller, whereby the timing advance value is also smaller for the fourth wireless terminal 2d than the fifth wireless terminal 2e.

Hence, the timing advance value is a parameter which can be used to indicate a distance from a particular network node. For example, for the first network node 1a, the first, second, third and fifth wireless devices 2a-c and 2e, are located between a first distance 12 and a second distance 13 from the first network node 1a, respectively corresponding to a first timing advance value and a second timing advance value.

The movement of the fourth and fifth wireless terminals 2d-e are indicated by the arrows connected to the respective wireless terminals 2d-e. The first wireless terminal 2a, second wireless terminal 2b and the third wireless terminal 2c share mobility characteristics, i.e. they move in essentially the same way, e.g. in terms of position and/or direction and speed. This is detected in the cellular network and the wireless terminals 2a-c are assigned to a mobility group 9 to simplify network operations related to the wireless terminals 2a-c of the mobility group 9.

The mobility group 9 can be defined using any one or more wireless device specific parameters, such as timing advance values, position (e.g. using triangulation or satellite positioning such as global positioning system (GPS)), speed, direction and relative position of the wireless terminals.

The mobility group can for example be useful to manage to a set of wireless terminals being in the same vehicle, such as a car, bus, train, etc.

As seen from the arrow of the mobility group 9, the wireless terminals 2a-c of the mobility group are moving from the first cell towards the second cell 5b. If the movement continues, at some point (as is described in more detail below) the wireless terminals 2a-c of the mobility group need to be handed over from the first network node 1a to the second network node 1b. In this handover context, the first network node 1a is a source network node and the second network node 1b is a target network node. According to embodiments herein, some or all of the wireless devices of the mobility group 9 are considered to still belong to a mobility group after the handover.

There are several effects as a result from identifying a mobility group 9 of wireless terminals for which similar mobility handling is useful. Firstly, handover can be triggered faster (e.g. due to knowledge about group mobility and which wireless terminals belong to the same mobility group). Secondly, signalling can be more efficient (e.g. by grouping multiple handovers together in same messages incurring less overhead). Thirdly, handling is made more robust (e.g. by comparing measurement from several wireless terminals).

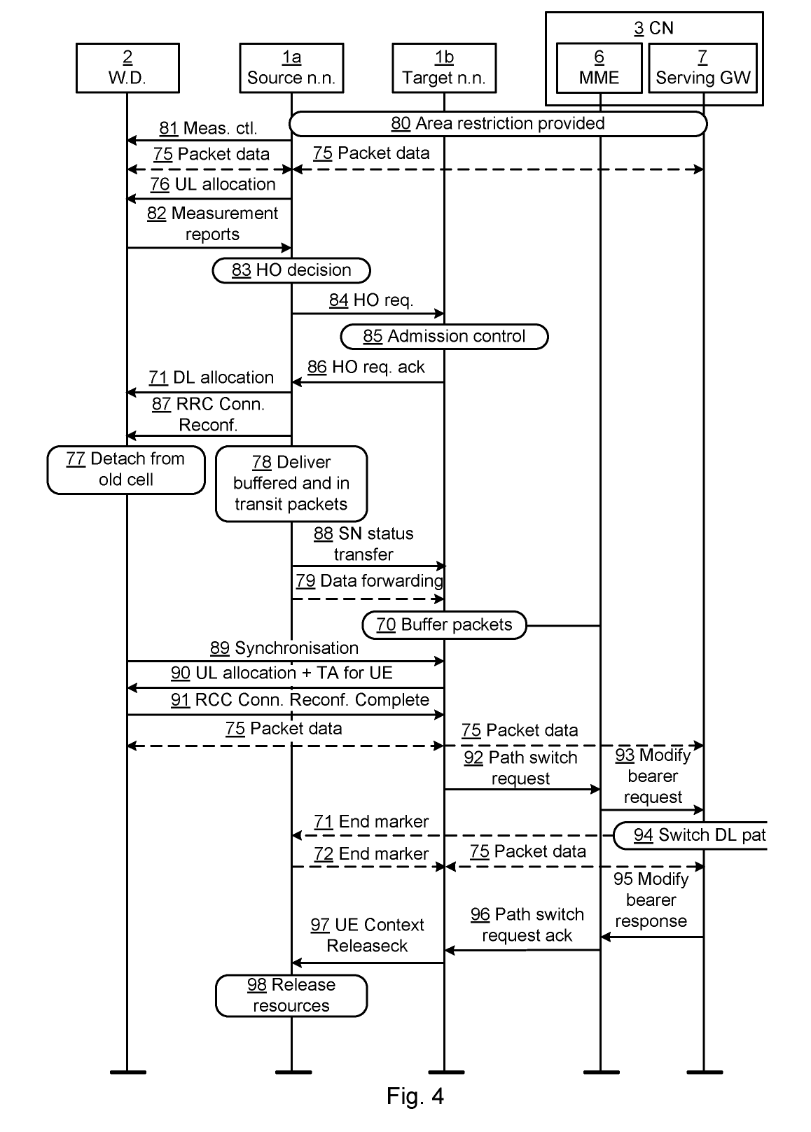

FIG. 4 is a sequence diagram illustrating an example of signalling for handover of a wireless device 2 from a source network node 1a to a target network node 1b (using the example illustrated in FIG. 2 above). It is to be noted that handover does not need to follow this example and can be performed in any suitable way to transfer a wireless device 2 from a source network node 1a to a target network node 1b, which is performed in communication with the MME 6 and the serving gateway 7, which are both part of the core network 3. FIG. 4 is related to control plane steps.

Firstly, an area restriction can be provided 80. The area restriction defines any restrictions of movement for the wireless device 2.

The source network node 1a then configures 81 the wireless device 2 measurement procedures by sending a measurement control message 81 to the wireless device 2. The measurement control takes into consideration any provided area restriction, since there is no point for the wireless device to provide measurements associated with areas where the wireless device is restricted from attaching.

Based on packet data 75, and UL allocation 76 from the source network node 1a, the wireless device measures radio characteristics and is thus triggered to send one or more MEASUREMENT REPORTS 82 as defined by the measurement control message 81, e.g. system information, specification etc.

The source network node 1a then makes a handover decision 83 based on the MEASUREMENT REPORT 82 and optionally RRM (Radio Resource Management) information, whether to perform handover for the wireless device 2. In this example, this is a positive decision and the wireless device 2 is to be handed over to the target network node 1b.

The source network node 1a then issues a HANDOVER REQUEST message 84 to the target network node 1b, passing necessary information to prepare the handover at the target side. This message can include information that the wireless device 2 belongs to a particular mobility group (9 of FIG. 2).

Admission Control 85 may optionally be performed by the target network node 1b.

The target network node 1b then prepares handover with L1 (Level 1)/L2 (Level 2) and sends a HANDOVER REQUEST ACKNOWLEDGE message 86 to the source network node 1a. The HANDOVER REQUEST ACKNOWLEDGE message 86 includes an Information Element (IE) called “Target network node to Source network node Transparent Container”. This IE basically contains the handover command message (RRCConnectionReconfiguration that includes the mobilityControlInfo IE) that is sent to the wireless device 2 in the next step. Some of the main elements of the RRCConnectionReconfiguration message are:

a. An optional measurement configuration (measConfig IE) to be used in the target cell.

b. Mobility control information (mobilityControlInfo IE), which is included only during handovers. This IE includes important information needed by the wireless device 2 to execute the handover such as the PCI of the target cell, Cell Radio Network Temporary Identifier (C-RNTI) assigned to the wireless device 2 in the target cell, timer value for handover expiry, dedicated preamble for Random Access Channel (RACH) in the target cell, carrier frequency/bandwidth to be used in the UL/DL and common radio resource configurations.

c. Dedicated radio resource configuration (radioResourceConfigDedicated IE), which mainly contains lists of DRB (Data Radio Bearers)/SRBs (Signalling Radio Bearers) to add or modify (srb-ToAddModList and drb-ToAddModList IEs, respectively) and if the list of DRBs to release, if any (drb-ToReleaseList IE). The lists are populated based on the admission control decision.

Additional information can also be included in the RRCConnectionReconfiguration message such as information related to security and carrier aggregation.

As soon as the source network node 1a receives the HANDOVER REQUEST ACKNOWLEDGE, or as soon as the transmission of the handover command is initiated in the downlink, user plane data forwarding may be initiated and a DL allocation message 71 is sent from the source network node 1a to the wireless device 2.

Furthermore, the source network node 1a sends an RRC message 87 to perform the handover to the wireless device 2, i.e. RRCConnectionReconfiguration message including the mobilityControlInformation, which was received in the transparent container included in the HANDOVER REQUEST ACKNOWLEDGE 86 received from the target network node 1b.

At this stage, the wireless device 2 detaches 77 from the old cell of the source network node 1a and synchronises with the new cell of the target network node 1b. Also, the source network node 1a delivers 78 any buffered and in transit packets to the target network node 1b.

The source network node 1a then sends a SN STATUS TRANSFER message 88 to the target network node 1b and data is forwarded 79 to the target network node 1b.

After receiving the RRCConnectionReconfiguration message including the mobilityControlInformation, the wireless device 2 performs the synchronisation 89 to the target network node 1b and accesses the target cell of the target network node 1b via RACH.

The target network node 1b then responds with UL allocation and timing advance values 90 to the wireless device 2.

When the wireless device 2 has successfully accessed the target cell of the target network node 1b, the wireless device 2 sends an RRCConnectionReconfigurationComplete message 91 to confirm the handover. The target network node 1b can now begin sending packet data 75 to the wireless device 2, relayed to/from the serving gateway 7.

The target network node 1b then sends a PATH SWITCH REQUEST message 92 to MME 6 to inform that the wireless device 2 has changed cell. In response to this, the MME 6 sends a MODIFY BEARER REQUEST 93 message to the serving gateway 7.

The serving gateway 7 can then switch the downlink data path 94 to the target side, after which the Serving gateway 7 sends one or more “end marker” packets 71 on the old path to the source network node 1a and then can release any U-plane/TNL (Transport Network Layer) resources towards the source network node 1a, such that the source network node 1a sends an end marker message 72 to the target network node 1b. The packet data 75 from to the MME 6 is then routed via the target network node 1b.

At this point, the serving gateway 7 sends a MODIFY BEARER RESPONSE message 95 to MME 6.

The MME 6 confirms the PATH SWITCH REQUEST message with the PATH SWITCH REQUEST ACKNOWLEDGE message 96 to the target network node 1b.

By sending the UE CONTEXT RELEASE message 97 to the source network node 1a, the target network node 1b informs success of handover to source network node 1a and triggers the release of resources by the source network node 1a.

Upon receipt of the UE CONTEXT RELEASE message 97, the source network node 1a can release 98 radio and C-plane related resources associated to the context of the wireless device 2. Any pursuing data forwarding may continue.

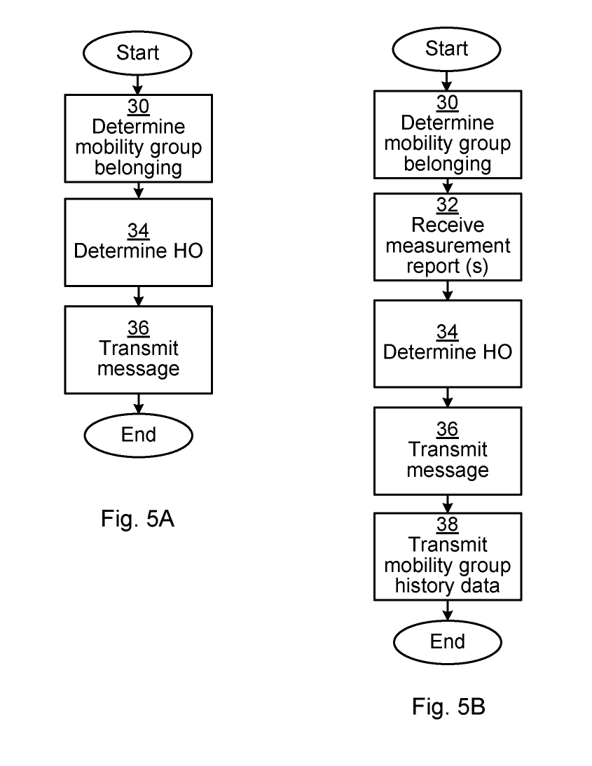

FIGS. 5A-B are flow charts illustrating assisting handover of wireless devices from a source network node to a target network node in, performed in a source network node such as the source network node of FIG. 2. The method illustrated in FIG. 5A will be described first.

In a determine mobility group step 30, the source network node determined that a first wireless device belongs to a mobility group (see 9 of FIG. 2), as described above. The mobility group comprises at least two wireless devices determined to share mobility characteristics.

In a determine HO step 34, the source network node determines that at least the first wireless device should be handed over to the target network node. This can be due to the first wireless device moving out of one cell and into another cell, which in this embodiment indicates that a handover is beneficial. If the measurement of one (or more) wireless devices of the mobility group indicate that a handover is beneficial, it is likely that all wireless devices of the mobility group would benefit from the same handover.

The determination of handover can be based on uplink measurements. Another situation can be in hierarchical deployments with great variations of cell coverage and a lot of overlapping or inclusion of cell coverage. In such a situation, the target cell can sometimes be known to have the same, and possibly more, coverage than the source. Hence, handover could occur blindly without first receiving a measurement report from the wireless device, e.g. for load balancing purposes.

In a transmit message step 36, a message is transmitted to the target network node, wherein the message allows the target node to identify that the first wireless device belongs to the mobility group. For example, the message can indicate that the first wireless device belongs to the mobility group. The message can e.g. be a handover request message and/or a handover preparation message. Optionally, the message further comprises identification information regarding an identification method of how the mobility group was first identified. This optional identification information can be an indicator of how reliable the mobility grouping is, which can be used by the target network node to determine how often the mobility group should be revalidated. For example, a more reliable group may not need to be revalidated as a less reliable group. Revalidation here means a revalidation of the mobility group members, to evaluate which wireless devices (if any) will continue to be part of the mobility group.

Moreover, if the identification method indicated in any optional identification information part of the message is not supported by the target network node, revalidation using the same identification method is not possible. This can be considered when the group is revalidated. Optionally, an identifier of the mobility group is a globally unique identifier of the mobility group.

Optionally, the message is a composite message comprising bearer information of all wireless devices belonging to the mobility group. The composite message is then a single message used for all wireless devices of the mobility group, which makes efficient use of messaging resources. Alternatively, one message is sent for each wireless device.

Optionally, the message comprises an identifier of the mobility group, while the message omits any identifiers of wireless devices. The target network node then needs to retrieve the mobility group members (wireless devices) separately, e.g. by querying the source network node or by querying the core network, such as an MME.

FIG. 5B is similar to FIG. 5A and only additional or different aspects, compared to the method illustrated FIG. 5A, will now be described with reference to FIG. 5B.

Prior to the determine HO step 34, there is here a receive measurement report (s) step 32, in which one or more measurement reports are received from one or more wireless devices belonging to the mobility group.

In the determine HO step 34, the source network node determines, based on the measurement report, that at least the first wireless device should be handed over to the target network node.

After (or before, not shown) the transmit message step 36, there is here a transmit mobility group history data step 38. Here, the source network node transmits mobility group history data, comprising information about activities of wireless devices of the mobility group. Optionally, the mobility group history data comprises at least one of: duration of the mobility group being connected to the source network node, duration of the mobility group staying together, movement speed of the mobility group, positioning data of the mobility group, timing advance data of the mobility group, visited cells of the mobility group, and data activity of wireless devices of the mobility group.

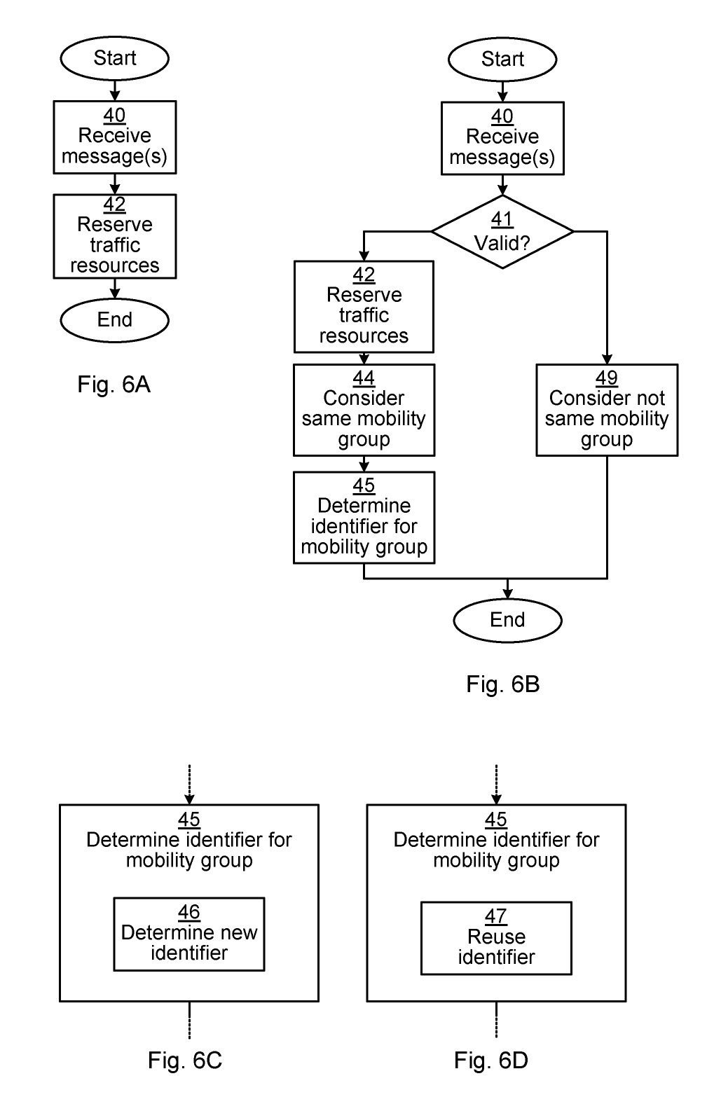

FIGS. 6A-D are flow charts illustrating assisting handover of wireless devices from a source network node to a target network node in, performed in a target network node such as the target network node of FIG. 2. The method illustrated in FIG. 6A will be described first.

In a receive message(s) step 40, the target network node receives at least one message from the source network node, wherein the at least one message indicates that a first wireless device and a second wireless device both belong to a mobility group determined to share mobility characteristics. The message(s) correspond to the message(s) sent in the transmit message step 36 of FIGS. 5A-B and can be one or more handover request message and/or one or more handover preparation messages.

In a reserve traffic resources step 42, traffic resources are reserved for the first and second wireless device. For example, space in an over the air interface or resources in the backhaul can be reserved based on the mobility group. Also, Quality of Service negotiation can be performed in this step.

FIG. 6B is similar to FIG. 6A and only additional or different aspects, compared to the method illustrated FIG. 6A, will now be described with reference to FIG. 6B.

The receive message(s) step 40 may optionally comprise receiving at least two handover requests from the source network node, each handover request comprising a wireless device identifier and a first mobility group identifier. In other words, there are multiple handover requests for multiple wireless devices but relating to the same mobility group.

In a conditional valid step 41, the target network node determines whether the mobility group is valid. When the mobility group is determined not to be valid, the method continues to a consider not same mobility group step 49. Otherwise, the method continues to the reserve traffic resources step 42.

There are several mechanisms for the target network node to determine how long a given group of wireless terminals as given by the group identifier is determined to be valid. For example: any one or more of the following solutions could be employed:

a) The validity of the group is determined by a timer. The value of the timer can either hard coded in the implementation or standard defined, or it can be signalled from the source network node. Once the timer expires, the group (and/or group identifier) is no longer considered valid.

b) The validity of the groups (and/or group identifier) can be determined implicitly by the source network node starting to use a different identifier (e.g. potentially an incremented version of the previous group identifier). In this solution it is possible to reuse group identifiers at a later stage (e.g. when the group identifier has rolled over).

c) The validity of the group can be indicated by including an ‘end group’ indicator in a message (e.g. handover request or preparation) associated to the last wireless device member of the group with a specific Group ID.

d) The validity of the group can be indicated by including a ‘new group’ indicator in a message associated to a first wireless device member of the group with a specific Group ID.

In case the target network node receives incoming handover associated with a group (and/or group identifier) that is no longer considered valid, the target network node can consider that the wireless terminals associated with these handovers does not belong to the same group as wireless terminals that arrived earlier using the same group identifier.

After the reserve traffic resources step 42, there is here a consider same mobility group step 44, in which the target network node considers that wireless devices respectively associated with the at least two handover requests belong to the same mobility group, identified by the first mobility group identifier.

After (or before, not shown) the consider same mobility group step 44, there is a determine identifier for mobility group step 45, in which an identifier for the mobility group is determined.

In the consider not same mobility group step 49, the target network node considers the first wireless device and second wireless device not to belong to the same mobility group.

In FIG. 6C, the determine identifier for mobility group step 45 comprises a determine new identifier substep 46, in which a new identifier for a mobility group comprising the first wireless device and the second wireless device is determined.

In FIG. 6D, the determine identifier for mobility group step 45 comprises a reuse identifier substep 47, in which the identifier for the mobility group of the handover request is reused in further handovers.

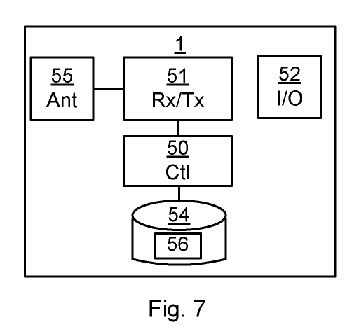

FIG. 7 is a schematic diagram illustrating some components of the network nodes of FIGS. 1 and 2.

A processor 50 is provided using any combination of one or more of a suitable central processing unit (CPU), multiprocessor, microcontroller, digital signal processor (DSP), application specific integrated circuit etc., capable of executing software instructions 56 stored in a computer program product 54, e.g. in the form of a memory. The processor 50 may be configured to execute the method described with reference to FIGS. 5A-B and 6A-D above as well as the procedures described below.

The computer program product 54 may be a memory or any combination of read and write memory (RAM) and read only memory (ROM). The memory also comprises persistent storage, which, for example, may be any single one or combination of magnetic memory, optical memory, solid state memory or even remotely mounted memory.

The network node 1 further comprises an I/O interface 52 for communicating with the core network and optionally with other network nodes.

The network node 1 also comprises one or more transceivers 51, comprising analogue and digital components, and a suitable number of antennas 55 for radio communication with wireless devices within one or more radio cells. The processor 50 controls the general operation of the network node 1, e.g. by sending control signals to the transceiver 51 and receiving reports from the transceiver 51 of its operation.

Further aspects and embodiments will now be described. The features described below can be combined, where applicable, with one or more embodiments described above.

LTE will be used as the exemplifying radio access technology. However, these embodiments are essentially equally applicable to other radio access technologies as well (e.g. WCDMA, CDMA2000 (1xRTT, EV-DO), Wi-Fi (802.11)).

The network nodes or node elements (NE), also referred to as eNodeB, are managed by a domain manager (DM), also referred to as the operation and support system (OSS). A DM may further be managed by a network manager (NM). Two NEs are interfaced by X2, whereas the interface between two DMs is referred to as Itf-P2P. The management system may configure the network elements, as well as receive observations associated to features in the network elements. For example, DM observes and configures NEs, while NM observes and configures DM, as well as network node via DM.

In embodiments herein, it is further assumed that any function that automatically optimizes network node parameters can in principle execute in the network node, DM, or the NMS. Such features are referred to as Self-Organizing Network (SON) features.

### Wireless Device Measurements

Wireless terminals can be configured to report measurements, mainly for the sake of supporting mobility. As specified in 3GPP TS 36.331, the E-UTRAN (evolved Universal Terrestrial Radio Access Network) provides the measurement configuration applicable for a wireless device in RRC_CONNECTED by means of dedicated signalling, i.e. using the RRCConnectionReconfiguration message. The following measurement configurations can be signalled to the wireless device:
Measurement objects: These define on what the wireless device should perform the measurements—such as a carrier frequency. The measurement object may also include a list of cells to be considered (white-list or black-list) as well as associated parameters, e.g. frequency- or cell-specific offsets.
Reporting configurations: These consist of the periodic or event-triggered criteria which cause the wireless device to send a measurement report, as well as the details of what information the wireless device is expected to report (e.g. the quantities, such as Received Signal Code Power (RSCP) for UMTS (Universal mobile telecommunications system) or Reference Signal Received Power (RSRP) for LTE, and the number of cells).
Measurement identities: These identify a measurement and define the applicable measurement object and reporting configuration. Each measurement identity links one measurement object with one reporting configuration. By configuring multiple measurement identities it is possible to link more than one measurement object to the same reporting configuration, as well as to link more than one reporting configuration to the same measurement object. The measurement identity is used as a reference number in the measurement report.
Quantity configurations: The quantity configuration defines the filtering to be used on each measurement. One quantity configuration is configured per RAT (Radio Access Technology) type, and one filter can be configured per measurement quantity.
Measurement gaps: Measurement gaps define time periods when no uplink or downlink transmissions will be scheduled, so that the wireless device may perform the measurements (e.g. inter-frequency measurements where the wireless device has only one Tx/Rx unit and supports only one frequency at a time). The measurement gaps are common for all gap-assisted measurements

The E-UTRAN configures only a single measurement object for a given frequency, but more than one measurement identity may use the same measurement object. The identifiers used for the measurement object and reporting configuration are unique across all measurement types. It is possible to configure the quantity which triggers the report (RSCP or RSRP) for each reporting configuration.

In LTE, the most important measurements metric used are the Reference Signal Received Power (RSRP) and Reference Signal Received Quality (RSRQ). RSRP is a cell specific measure of signal strength and it is mainly used for ranking different cells for handover and cell reselection purposes, and it is calculated as the linear average of the power of the Resource Elements (REs) which carry cell-specific Reference Signals (RSs). The RSRQ, on the other hand, also takes the interference into consideration by taking the total received wideband power into account as well.

One of the measurement configuration parameters that wireless terminals receive from their serving eNBs is the S-measure, which tells the wireless device when to start measuring neighbouring cells. If the measured RSRP of the serving cell falls below the S-measure, indicating the signal of the serving cell is not that strong anymore, the wireless device starts measuring the signal strength of RSs from the neighbouring cells. The S-measure is an optional parameter and different S-measure values can be specified for initiating intra-frequency, inter-frequency and inter-RAT measurements.

Once the wireless device is enabled for measuring, it can report any of the following:
The serving cell
Listed cells (i.e. cells indicated as part of the measurement object);
Detected cells on a listed frequency (i.e. cells which are not listed cells but are detected by the wireless device).

There are several measurement configuration parameters that specify the triggering of measurement reports from the wireless device. The following event-triggered criteria are specified for intra-RAT measurement reporting in LTE:
Event A1: Primary serving cell (PCell) becomes better than absolute threshold.
Event A2: PCell becomes worse than absolute threshold.
Event A3: Neighbour cell becomes better than an offset relative to the PCell.
Event A4: Neighbour cell becomes better than absolute threshold.
Event A5: PCell becomes worse than one absolute threshold and neighbour cell becomes better than another absolute threshold.
Event A6: Neighbour cell becomes better than an offset relative to a secondary cell (SCell)

For inter-RAT mobility, the following event-triggered reporting criteria are specified:
Event B1: Neighbour cell becomes better than absolute threshold.
Event B2: Serving cell becomes worse than one absolute threshold and neighbour cell becomes better than another absolute threshold.

The most widely used measurement report triggering event related to handover is A3. The triggering conditions for event A3 can be formulated as:

N>S+HOM [1]

where N and S are the signal strengths of the neighbour and serving cells, respectively, and HOM is the handover margin. HOM is the difference between the radio quality of the serving cell and the radio quality needed before attempting a handover. The radio quality is measured either using RSRP or RSRQ (see 3GPP TS 36.133 for further explanation).

The wireless device triggers the intra-frequency handover procedure by sending event A3 report to the network node. This event occurs when the wireless device measures that the target cell is better than the serving cell with a margin “HOM”. The wireless device is configured over RRC when entering a cell and the HOM is calculated from the following configurable parameters:

HOM=Ofs+Ocs+Off−Ofn−Ocn+Hys [2]

where:

Ofs is the frequency specific offset of the serving cell

Ocs is the cell specific offset (CIO) of the serving cell

Off is the a3-Offset

Ofn is the frequency specific offset of the neighbour cell

Ocn is the CIO of the neighbour cell

Hys is the hysteresis

If the condition in [1] is satisfied and it remains valid for a certain duration known as Time To Trigger (TTT), the wireless device sends a measurement report to the serving network node. When the serving network node gets the measurement report, it can initiate a handover towards the neighbour.

In addition to event-triggered reporting, the wireless device may be configured to perform periodic measurement reporting. In this case, the same parameters may be configured as for event-triggered reporting, except that the wireless device starts reporting immediately rather than only after the occurrence of an event.

### LTE Mobility in Connected Mode

The LTE handover preparation and execution can essentially be completed over the X2 interface without involving the core network. However, some details needs to be aligned over S1, which is an interface between the network node and core network, e.g. MME/S-GW. The handover mechanism can also be handled via the S1 interfaces forwarded by the MME.

To exemplify the handover procedure, consider the basic situation when neither MME nor S-GW changes due to the handover. See 3GPP TS 36.300 for more details.

One issue with existing solutions is that each wireless device is managed individually, and each mobility event is considered independently from mobility events associated to other wireless devices.

In a case of different and possibly numerous wireless devices following similar mobility trends, the above means that the network would have to individually evaluate every wireless device condition and execute handovers for every terminal within a very short time window. The latter might lead to delays in the execution of handovers and potentially failures due to high number of handovers and lack of anticipated handover preparation.

Current solutions do not rely on deducing common mobility behaviours for different terminals based on events monitored for each terminal. Such deduction would enable to group terminals together in a group that is subject to similar mobility behaviours. This would allow e.g. anticipating handover preparation and catering for more time for each handover execution. Also, this could allow enhanced mobility procedures aimed at handing over a whole group of terminals from source to target. In general, by identifying sets of wireless devices sharing similar mobility patterns, it would be possible to make mobility more robust. In addition it is beneficial to have mechanisms for maintaining information of these mobility patterns at handover to avoid the need for the target network node to re-identify wireless devices with similar mobility patterns.

In a first embodiment, a group identifier (e.g. Mobility Group ID) is added to S1 and/or X2 signaling (or other interfaces for other RATs than LTE) to indicate which mobility group the wireless device belongs to. This information can then be used by the target cell, base station or radio controller to optimize further mobility handling as according to previous IVDs taking in consideration which groups the wireless device belong to. This avoids the need to re-group wireless terminals in the target cell. The identifier can be transferred using S1 and/or X2 handover related signaling messages (e.g. Handover Request) or other non handover related S1 and/or X2 messages.

In an optional extension to the first embodiment, mechanisms are introduced for the target network node to determine how long a given group of wireless terminals as given by the group identifier is determined to be valid. Several different solutions are proposed.

a) The validity of the group is determined by a timer. The value of the timer can either hard coded in the implementation or standard defined, or it can be signalled from the source network node. Once the timer expires, the group (and/or group identifier) is no longer considered valid.

b) The validity of the groups (and/or group identifier) can be determined implicitly by the source network node starting to use a different identifier (e.g. potentially an incremented version of the previous group identifier). In this solution it is possible to reuse group identifiers at a later stage (e.g. when the group identifier has rolled over).

c) The validity of the group can be indicated by including an ‘end group’ indicator in a message (e.g. handover request or preparation) associated to the last wireless device member of the group with a specific Group ID.

d) The validity of the group can be indicated by including a ‘new group’ indicator in a message associated to a first wireless device member of the group with a specific Group ID.

In case the target network node receives incoming handover associated with a group (and/or group identifier) that is no longer considered valid, the target network node can consider that the wireless terminals associated with these handovers does not belong to the same group as wireless terminals that arrived earlier using the same group identifier.

In an optional extension to the first embodiment, the target network node assigns a new group identifier to a group which has performed incoming handover to the target network node for future handovers to other nodes. In this case, the group identifier becomes a temporary identifier assigned by each node.

In an optional extension to the first embodiment, the node that first identified that some wireless terminals belong to a mobility group assigns a unique identifier for the group (e.g. Global Mobility Group ID). In order to make the group identifier unique in this case the group identifier could contain information about the node that first identified the group (e.g. network node identifier) and/or be allocated from a specific range for which the node doing the allocation has been assigned and/or contain information about the time and date the group was identified. In this embodiment the target network node at handover reuses the same group identifier for the same group for future handovers to other nodes. This makes it possible (e.g. for statistical purposes) for the network to track a given mobility group's movement through the network.

In an optional extension to the first embodiment, the target network node once the group has performed handover to the target network node verifies if the mobility group is still valid or if it needs to be updated, i.e. performs revalidation.

a) In case the mobility group is no longer valid (e.g. due to that the wireless terminals are no longer moving according to same path) based on some parameters the target network node can stop using the group identifier of this group.

b) In case the mobility group is valid but the members of the group have partially changed. The target network node can decide which wireless terminals should continue to belong to the same group and which wireless terminals should be assigned to a new group (if needed).

In an optional extension to the first embodiment, the source network node sends a mobility group wireless device history Information Element (IE) in the S1 or X2 signaling towards the target network node. The mobility group wireless device history IE can contain information about the activities of the wireless terminals in the source network node, as well as information from previous nodes. This is achieved by the source network node appending information to a mobility group wireless device history IE received from previous nodes. The mobility group wireless device history IE can contain information about how long time the mobility group has stayed in the cell, how long time the group has stayed together as well as other mobility information about the group (e.g. speed (average, current, top), positioning info (absolute, relative), timing advance information, visited cells) as well as data activity of wireless terminals in the group (e.g. data volume over time, last activity). This information can be used by target network node for statistical purposes or to optimize the treatment of the wireless terminals belonging to this group.

In an optional extension to the first embodiment, the source network node can signal information over S1 or X2 to the target network node regarding in what way the group was first identified. Possible parameters include (i.e. timing advance, position, speed, relative position of the wireless terminals). This information can then be used by the target network node to determine if the mobility group is still valid or not, and/or if it needs to be updated.

In an optional extension to the first embodiment, the source network node, upon deciding to handover a set of wireless terminals that belong to the same mobility group, it creates one composite X2 handover request message that includes all the bearer information of all the wireless terminals in the set of wireless terminals within the group as well as the mobility group ID. In this way, no individual Handover request/ACK cycle are required for each wireless device in the set and at the same time the group mobility information of the wireless terminals in the set are also communicated.

In an optional extension to the first embodiment, the members of a mobility group are available at the MME, and the source network node, upon deciding to handover a set of wireless terminals that belong to the same mobility group, sends a Handover request that includes only the group ID. The target can communicate with the MME to get the detailed information of each member of this mobility group (including bearer information, etc.), to perform admission control and communicate it to the source. This extension is very valuable if X2 is not available between the source and the target, as the MME has to be involved for the handover (i.e. Source only sends group ID and target towards to the MME, and MME will provide all the other information in the S1 Handover request message towards the target.)

In an optional extension to the previous embodiments, when some of the wireless terminals are admitted and others are not, the source network node regroups the non-admitted wireless terminals in a new group and tries to hand them over to the next best handover target.

Looking again to FIG. 4 and FIG. 5A-B, shows an overview of the basic X2 handover procedure in E-UTRAN (LTE). This procedure is used as a base to illustrate further embodiments. Embodiments herein are also applicable to other signaling procedures and radio access technologies.

The following steps are performed by the source network node (e.g. network node) in relation to handover of wireless terminals belonging to a mobility group.

I. The source network node has determined that one or more wireless terminals belong to a mobility group

II. The source network node has configured the wireless device measurement for one or more wireless terminals belonging to the mobility group.

III. The source network node received one or more MEASUREMENT REPORT from one or more wireless terminals belonging to the mobility group.

IV. The source network nodes decide to initiate handover procedures for one or more wireless terminals belonging to the mobility group.

V. The source network node issues a HANDOVER REQUEST message (or message with similar functionality) for one or more wireless terminals belonging to the mobility group to the target network node passing necessary information to prepare the handover at the target side. This message also includes an indication to the target network node that the wireless device belongs to a mobility group. This can include or be made up of a Mobility Group ID.

VI. (optionally) The source network node includes information in the HANDOVER REQUEST regarding in what way the mobility group was first identified. Possible parameters include (i.e. timing advance, position, speed, relative position of the UEs). This information can then be used by the target network node to determine if the mobility group is still valid or not, and/or if it needs to be updated.

Similarly the target network node (e.g. network node) performs the following steps, looking again to FIG. 4 and FIGS. 6A-D.

a. It receives the HANDOVER REQUEST message containing mobility group information (e.g. Mobility Group ID).

b. It determines that the wireless terminals associated with this message belong to a mobility group e.g. identified by a Mobility Group ID.

c. (optionally) The target network node also determine if also other wireless terminals which are handed over using different HANDOVER REQUEST messages belong to the same mobility group.

d. (optionally) The target network node can assign a new Mobility Group Identifier to the mobility group of wireless terminals identified in the previous steps. This Mobility Group Identifier used for further handovers to other target network nodes.

e. (optionally) The same Mobility Group Identifier as received form the source network node is used for further handovers to other target network nodes.

f. (optionally) The target network node performs measurements to determine if all the wireless terminals associated with a mobility group that was identified in a different node (e.g. the source network node) still belong to the same mobility group. The determining can be based on several different parameters including wireless device speed (average, current, top), positioning info (absolute, relative), timing advance information, etc. If it is determined that a wireless device no longer belong to the mobility group this wireless device will not be handled any longer as part of the mobility group.

### Optional Extension 1

The act of determining in the source network node if also other wireless terminals which are handed over using different HANDOVER REQUEST messages belong to the same mobility group (Step III above) is done using one or more validity criteria for the mobility group. These validity criteria could include:

a) The validity of the mobility group is determined by a timer. The value of the timer can either hard coded in the implementation or standard defined, or it can be signalled from the source network node. Once the timer expires, the mobility group (and/or group identifier) is no longer considered valid meaning that wireless terminals associated with later HANDOVER REQUEST messages from the source to target network node, are not determined to belong to the same mobility group as wireless terminals associated with earlier HANDOVER REQUEST messages.

b) The validity of the mobility groups (and/or group identifier) can be determined implicitly by the source network node starting to use a different identifier (e.g. potentially an incremented version of the previous group identifier). When the target network node receives this new identifier it knows that no more wireless terminals will arrive that are associated with the mobility group of wireless terminals using an earlier identifier. In this solution it is possible to reuse group identifiers at a later stage (e.g. when the group identifier has rolled over).

c) The validity of the mobility group can be indicated by including an ‘end group’ indicator in a message (e.g. handover request or preparation) associated to the last wireless device member of the mobility group with a specific Mobility Group ID. When the target network node receives this end identifier it knows that no more wireless terminals will arrive that are associated with this mobility group (as identified by the Mobility Group ID).

d) The validity of the mobility group can be indicated by including a ‘new group’ indicator in a message associated to a first wireless device member of the mobility group with a specific Mobility Group ID. When the target network node receives this identifier it knows that no more wireless terminals will arrive that are associated with an earlier mobility group.

The principle above can be translated to corresponding functionality also in source network node. E.g. sending of identifiers, timers, etc.

### Optional Extension 2

In addition to following the steps described above, the source network node can also assign an identifier for the mobility group (e.g. Mobility Group ID). This identifier is included in the HANDOVER REQUEST message to the target network node.

This group identifier could be made up by concatenating two or more of the following parameters:
a random value
a sequence number that is incremented for every new mobility group that is identified
a node identity (e.g. of the source network node)
a cell identity (in which the mobility group was first identified)
a parameter indicating time and/or date
a sequence number within a specific range which is assigned to the source network node.

### Optional Extension 3

In addition to following the steps described above the source network node sends a mobility group wireless device history Information Element (IE) in the HANDOVER REQUEST message (send over S1 or X2) towards the target network node. The mobility group wireless device history IE can contain information about the activities of the wireless terminals in the source network node, as well as information from previous nodes.

Example procedure in the source and/or target network node could include:

1. Receiving Mobility Group wireless device history IE from source network node in a HANDOVER REQUEST message

2. Appending information to the Mobility Group wireless device history IE

3. Transmitting the Mobility Group wireless device history IE to a target network node in a HANDOVER REQUEST message

The mobility group wireless device history IE can contain information about how long time the mobility group has stayed in the cell, how long time the mobility group has stayed together as well as other mobility information about the mobility group (e.g. speed (average, current, top), positioning info (absolute, relative), timing advance information, visited cells) as well as data activity of wireless terminals in the mobility group (e.g. data volume over time, last activity). It can also contain information about the cause of previous handovers e.g. due to coverage reasons, or for load balancing reasons. This information can be used by target network node for statistical purposes or to optimize the treatment of the wireless terminals belonging to this mobility group. An example of such optimized treatment can be to avoid Mobility Group ping pong effects, namely if the history shows that a recent handover between target and source occurred, then there will be a higher hysteresis in triggering the next mobility group handover. The latter can be achieved by allowing the serving network node to wait for more wireless device measurement reports (from different wireless terminals in the mobility group) pointing at a certain target before triggering a mobility group mobility.

### Optional Extension 4

In addition to following the steps described above, the source network node, upon deciding to handover a set of wireless terminals that belong to the same mobility group, it can create one composite HANDOVER REQUEST message that includes all the bearer information of all the wireless terminals in the set of wireless terminals within the mobility group as well as the mobility group ID. This way, no individual Handover request/ACK cycle are required for each wireless device in the set and at the same time the mobility group mobility information of the wireless terminals in the set are also communicated.

When the target network node receives this message it will perform admission control, allocate resources etc. for all the wireless terminals in the message. In scenario when only some of the wireless terminals are admitted and others are not, the target indicates this to the source network node in the handover acknowledgement message.

In case some wireless terminals where rejected at handover the source network node then has the option to re-group the non-admitted wireless terminals in to a new mobility group and try to hand them over to the next best handover target.

In an optional extension to the first embodiment, the members of a mobility group are available at the MME, and the source network node, upon deciding to handover a set of wireless terminals that belong to the same mobility group, sends a Handover request that includes only the Mobility Group ID. The target can communicate with the MME to get the detailed information of each member of this mobility group (including bearer information, etc.), to perform admission control and communicate it to the source. This extension is very valuable if X2 is not available between the source and the target, as the MME has to be involved for the handover (i.e. Source only sends Mobility Group ID and target towards to the MME, and MME will provide all the other information in the S1 Handover request message towards the target.)

### Extension 5

In scenarios where S1 handover procedure is used and when the members of a mobility group are available at the MME, and the source network node, upon deciding to handover a set of wireless terminals that belong to the same mobility group, the source may sends a Handover request that includes only the Mobility Group ID. The target can communicate with the MME to get the detailed information of each member of this mobility group (including bearer information, etc.), to perform admission control and communicate it to the source. This extension is applicable if only S1 handover is supported between the source and the target, as the MME has to be involved for the handover (i.e. Source only sends Mobility Group ID and target towards to the MME, and MME will provide all the other information in the S1 Handover request message towards the target.)

Embodiments presented herein extend these advantages further by making it possible to maintain the mobility grouping of wireless devices after inter-node handover. This avoids the need for performing new grouping procedures in the target network node, which reduces processing requirements and improves mobility robustness.

The invention has mainly been described above with reference to a few embodiments. However, as is readily appreciated by a person skilled in the art, other embodiments than the ones disclosed above are equally possible within the scope of the invention.

1-30. (canceled)

31. A method for assisting handover of wireless devices from a source network node to a target network node, the method being performed in the source network node and comprising:
determining that a first wireless device belongs to a mobility group, wherein the mobility group comprises at least two wireless devices served by the source network node determined to share mobility characteristics;
determining that at least the first wireless device should be handed over to the target network node; and
transmitting a message to the target network node, wherein the message indicates that the first wireless device belongs to the mobility group.

32. The method according to claim 1, further comprising:
receiving a measurement report from a wireless device belonging to the mobility group;
and wherein the determining that at least the first wireless device should be handed over to the target network node is based on the measurement report.

33. The method according to claim 1, wherein, in the transmitting, the message is a handover request message.

34. The method according to claim 31, wherein the message comprises information regarding how the mobility group was first identified.

35. The method according to claim 31, wherein an identifier of the mobility group is a globally unique identifier of the mobility group.

36. The method according to claim 31, further comprising transmitting mobility group history data, comprising information about activities of wireless devices of the mobility group.

37. The method according to claim 36, wherein the mobility group history data comprises at least one of: duration of the mobility group being connected to the source network node, duration of the mobility group staying together, movement speed of the mobility group, positioning data of the mobility group, timing advance data of the mobility group, visited cells of the mobility group, and data activity of wireless devices of the mobility group.

38. The method according to claim 31, wherein the transmitting a message to the target network node comprises transmitting a composite message comprising bearer information of all wireless devices belonging to the mobility group.

39. The method according to claim 31, wherein the transmitting a message to the target network node comprises transmitting a message comprising an identifier of the mobility group, and wherein the message omits any identifiers of wireless devices.

40. A source network node arranged to assist handover of wireless devices from the source network node to a target network node, the source network node comprising:
a processor; and
a computer program product storing instructions that, when executed by the processor, causes the source network node to:
determine that a first wireless device belongs to a mobility group, wherein the mobility group comprises at least two wireless devices served by the source network node determined to share mobility characteristics;
determine that at least the first wireless device should be handed over to the target network node; and
transmit a message to the target network node, wherein the message indicates that the first wireless device belongs to the mobility group.

41. The source network node according to claim 40, further comprising instructions to receive a measurement report from a wireless device belonging to the mobility group; and wherein the instructions to determine that at least the first wireless device should be handed over to the target network node is based on the measurement report.

42. The source network node according to claim 40, wherein the message is a handover request message.

43. The source network node according to claim 40, wherein the message comprises information regarding how the mobility group was first identified.

44. The source network node according to claim 40, wherein an identifier of the mobility group is a globally unique identifier of the mobility group.

45. The source network node according to claim 40, further comprising instructions to transmit mobility group history data, comprising information about activities of wireless devices of the mobility group.

46. The source network node according to claim 45, wherein the mobility group history data comprises at least one of: duration of the mobility group being connected to the source network node, duration of the mobility group staying together, movement speed of the mobility group, positioning data of the mobility group, timing advance data of the mobility group, visited cells of the mobility group, and data activity of wireless devices of the mobility group.

47. The source network node according to claim 40, wherein the instructions to transmit a message to the target network node comprise instructions to transmit a composite message comprising bearer information of all wireless devices belonging to the mobility group.

48. The source network node according to claim 40, wherein the instructions to transmit a message to the target network node comprise instructions to transmit a message comprising an identifier of the mobility group, and wherein the message omits any identifiers of wireless devices.

49. A method for assisting handover of wireless devices from a source network node to a target network node, the method being performed in the target network node and comprising:
receiving at least one message from the source network node, wherein the at least one message indicates that a first wireless device and a second wireless device both belong to a mobility group determined to share mobility characteristics; and
reserving traffic resources for the first and second wireless device.

50. The method according to claim 49, wherein, in the receiving, the message is a handover request message.

51. The method according to claim 49, wherein
the receiving at least one message comprises receiving at least two handover requests from the source network node, each handover request comprising a wireless device identifier and a first mobility group identifier;
and wherein the method further comprises:
considering that wireless devices respectively associated with the at least two handover requests belong to the same mobility group identified by the first mobility group identifier.

52. The method according to claim 49, further comprising:
determining a Previously presented identifier for a mobility group comprising the first wireless device and the second wireless device.

53. The method according to claim 49, further comprising:
reusing the identifier for the mobility group of the handover request in further handovers.

54. The method according to claim 49, further comprising:
determining whether the mobility group is valid; and
when the mobility group is determined not to be valid, considering the first wireless device and second wireless device not to belong to the same mobility group.

55. A target network node arranged to assist handover of wireless devices from a source network node to the target network node, the target network node comprising:
a processor; and
a computer program product storing instructions that, when executed by the processor, causes the target network node to:
receive at least one message from the source network node, wherein the at least one message indicates that a first wireless device and a second wireless device both belong to a mobility group determined to share mobility characteristics; and
reserve traffic resources for the first and second wireless device.

56. The target network node according to claim 55, wherein the message is a handover request message.

57. The target network node according to claim 55, wherein
the instructions to receive at least one message comprise instructions to receive at least two handover requests from the source network node, each handover request comprising a wireless device identifier and a first mobility group identifier;
and wherein the instructions further comprise instructions to:
consider that wireless devices respectively associated with the at least two handover requests belong to the same mobility group identified by the first mobility group identifier.

58. The target network node according to claim 55, further comprising instructions to:
determine a Previously presented identifier for a mobility group comprising the first wireless device and the second wireless device.

59. The target network node according to claim 55, further comprising instructions to:
reuse the identifier for the mobility group of the handover request in further handovers.

60. The target network node according to claim 55, further comprising instructions to determine whether the mobility group is valid; and to, when the mobility group is determined not to be valid, consider the first wireless device and second wireless device not to belong to the same mobility group.
